(19) United States
(12) Patent Application Publication
(10) Pub. No.: US 2006/0215336 A1
(43) Pub. Date: Sep. 28, 2006

(54) ESD foam ground clip

(75) Inventor: Lance L. Sundstrom, Pinellas Park, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/089,184

(22) Filed: Mar. 24, 2005

(51) Int. Cl. H02H 9/00

(52) U.S. Cl. 361/56

(57) ABSTRACT

Methods and systems are provided for protecting an electronic device from electrostatic discharge when inserting and removing the electronic device from ESD foam. In one embodiment, an ESD foam ground clip is presented. The clip comprises a low-impedance contact and a ground connector adapted to electrically connect the low-impedance contact to an electrical ground.

### GOVERNMENT LICENSE RIGHTS

The U.S. Government may have certain rights in the present invention as provided for by the terms of Contract No. N00030-04-C-0010 awarded by the Dept. of Navy Strategic Systems Programs.

### TECHNICAL FIELD

The present invention generally relates to the field of semiconductor chip devices and more specifically the protection of electronic devices from electrostatic discharge damage.

### BACKGROUND

Many modern electronic devices, such as a magnetic tunnel junctions (MTJ) memory bit, are easily damaged by electro static discharge (ESD). For example, MTJ bits have a breakdown of only 1.5 volts. In a typical laboratory or manufacturing environment, ambient electrical noise can cause electrostatic charges to build up on surfaces, operators, devices and equipment that are several times the breakdown voltage of some electronic devices. Existing procedures for protecting such devices do not protect down to these low breakdown voltages. Existing protection devices and materials, such as ESD foams, ESD boxes and grounded ESD mats also provide insufficient protection. When fully inserted into ESD foam, the pins of an electronic device are all held at the same voltage because the ESD foam conducts between the pins just enough to dissipate any differential electrostatic charges between the device pins. However, ESD foam, sitting in an ESD box, placed on a grounded ESD mat can pick up enough voltage from lighting equipment noise (2 volts peak-to-peak can be typically measured) to destroy MTJ bits housed in ceramic package devices, when the device pins are in the process of being inserted into, or removed from, ESD foam. The first insertion or last extraction point or points of contact between an electronic device and ESD foam is subject to any differential voltage developed between the electronic device and the ESD foam.

For the reasons stated above and for other reasons stated below which will become apparent to those skilled in the art upon reading and understanding the specification, there is a need in the art for methods and systems to prevent ESD damage to electronic devices having low breakdown voltages when inserting them into, or removing them from, ESD foams.

### SUMMARY

The embodiments of the present invention provide methods and systems to prevent ESD damage to electronic devices having low breakdown voltages when inserting the devices into, or removing them from, ESD foams, as well as solving other problems and will be understood by reading and studying the following specification.

In one embodiment, an ESD foam ground clip is provided. The clip comprises a low-impedance contact and a ground connector adapted to electrically connect the low-impedance contact to an electrical ground.

In another embodiment, a method for inserting an electronic device into ESD foam is provided. The method comprises inserting a low-impedance contact into the ESD foam, connecting the low-impedance contact to ground; and inserting the pins of an electronic device into the ESD foam.

In yet another embodiment, a method for removing an electronic device from ESD foam is provided. The method comprises inserting a low-impedance contact into ESD foam, connecting the low-impedance contact to ground, and removing the electronic device pins from the ESD foam.

In yet another embodiment, an ESD foam grounding system is provided. The system comprises a low-impedance electrical contact means and means for electrically connecting the low-impedance contact means to an electrical ground.

In still another embodiment, a secondary electron emission shield for a flash x-ray system having electronic devices contained within an EMI enclosure is provided. The shield comprises ESD foam adapted with a low-impedance contact, wherein the ESD foam is located between a source of secondary electron emissions and the electronic devices, and a ground connector adapted to electrically connect the low-impedance contact to an electrical ground.

In still another embodiment an apparatus is provided. The apparatus comprises a printed wiring board having a first side and a second side, wherein one or more electronic devices are mounted on one or more of the first side and the second side. The apparatus further comprises one or more low-impedance contacts mounted on one or more of the first side and the second side; a ground bus adapted to electrically couple the one or more low-impedance contacts together; and ESD foam mounted onto the one or more low-impedance contacts between a source of secondary electron emissions and the one or more electronic devices.

In still yet another embodiment, a method for shielding electronic devices from secondary electron emissions in a flash x-tray test system is provided. The method comprises inserting a layer of ESD foam between a source of secondary electron emissions and the electronic devices, inserting one or more low-impedance contacts into the ESD foam, connecting the one or more low-impedance contact to ground; capturing electrons in the ESD foam, and draining electrons captured by the ESD foam to ground.

In still yet another embodiment, a secondary electron emission shield for a flash x-ray system having electronic devices contained within an EMI enclosure is provided. The shield comprises means for adapting ESD foam with a low-impedance electrical contact, and means for electrically connecting the low-impedance contact to an electrical ground.

In yet another embodiment, a low impedance contact is provided. The contact comprises a plurality of metal pins, a holding plate adapted to hold the plurality of metal pins approximately parallel to each other, and a ground bus. The ground bus is adapted to electrically couple each of the plurality of metal pins to each other.

### DRAWINGS

The present invention can be more easily understood and further advantages and uses thereof more readily apparent, when considered in view of the description of the preferred embodiments and the following figures in which:

FIGS. 1A, 1B, 1C and 1D are diagrams illustrating an ESD foam ground clip of one embodiment of the present invention;

FIGS. 2A and 2B are flow charts illustrating methods for inserting and removing electronic devices from ESD foam of one embodiment of the present invention;

FIG. 3A is a diagram of an electron collector for a flash x-ray testing system of one embodiment of the present invention;

FIGS. 3B and 3C are diagrams of an electronic apparatus adapted with an electron collector of one embodiment of the present invention;

FIGS. 4 is a flow chart illustrating a method for shielding electronic devices from secondary electron emissions of one embodiment of the present invention.

In accordance with common practice, the various described features are not drawn to scale but are drawn to emphasize features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the ESD Foam Ground Clip address the problems of ESD damage by providing a low impedance controlled discharge path to ground for electrostatic charges picked up by ESD foam. With embodiments of the current invention, static charge cannot accumulate on ESD foam because induced charges will immediately dissipate to ground through the invention. Thus, electrostatic voltage accumulation will not exceed the breakdown voltage of electronic devices, such as MTJ bits, and other discrete and integrated circuit (IC) devices.

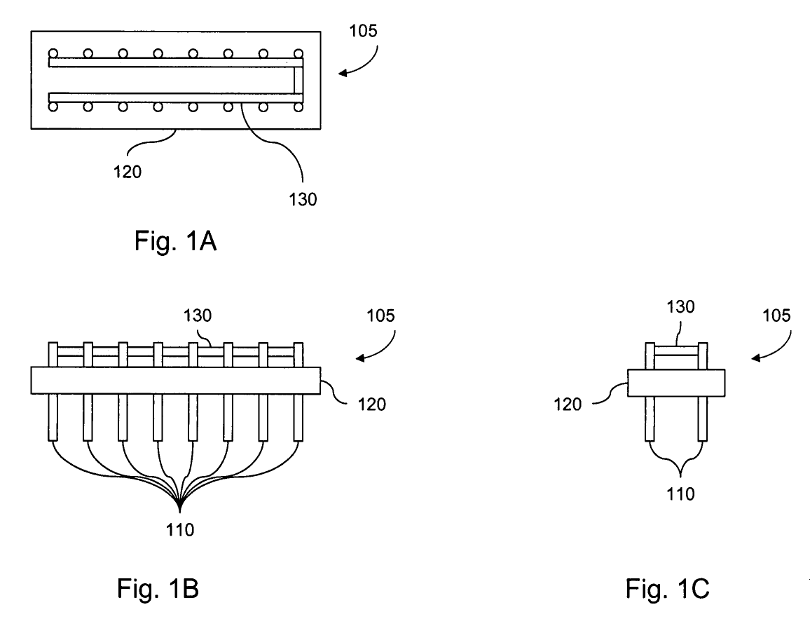

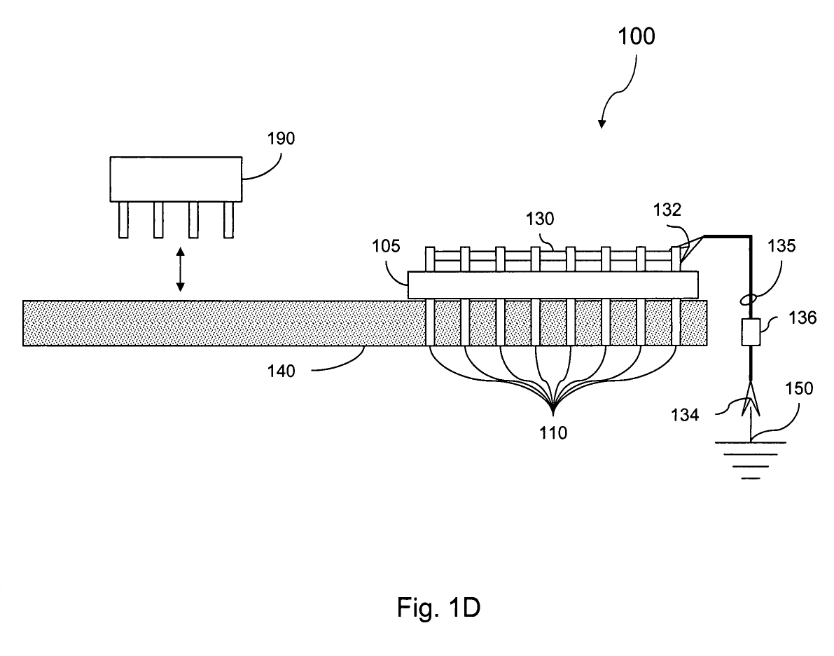

One embodiment of an ESD foam ground clip 100 comprising a low impedance contact and a ground connector is depicted in FIG. 1D. FIGS. 1A, 1B and 1C are respective top, front, and side view illustrations of a contact 105 of one embodiment of the present invention. In one embodiment, a plurality of pins 110 perpendicularly penetrate, and are held in place by, a holding plate 120. In one embodiment, each of the plurality of pins 110 are electrically coupled to each other through ground bus 130. As illustrated by FIG. 1D, embodiments of the present invention function by removing electrostatic charges held within a piece of ESD foam 140 and maintaining the ESD foam at ground potential. In one embodiment the plurality of pins 110 of contact 105 are inserted into a pad of ESD foam 140. In one embodiment, ground bus 130 is further electrically coupled to electrical ground 150 through a ground connector 135. In one embodiment, ground connector 135 is a wire lead removably attached to ground bus 130 of contact 105 through a clip 132 such as, but not limited to, a ball clip terminal, a banana jack and plug, or an alligator clip. In one embodiment, ground connector 135 is a wire lead removably attached to electrical ground 150 through a clip 134 such as, but not limited to, a ball clip terminal, a banana jack and plug or an alligator clip. Any Electrostatic charges induced in foam 140 are electrically attracted to plurality of pins 110 and are drained to ground 150 through ground connector 135. In one embodiment, ground connector 135 further comprises a resistor 136 in order to control the flow of charges from contact 105 to ground 150 and to provide operator protection. With ESD foam 140 held at or near ground potential by embodiments of the present invention, a grounded ESD sensitive electronic device 190, (e.g. an electronic device having one or more MTJ bit sites) can be inserted into, or removed from ESD foam 140 without danger of developing differential voltages across its pins by grounded technicians or equipment handling device 190.

The exact spacing, dimensions and number of pins 110 necessary for contact 105 is readily determined by one skilled in the art upon reading this specification and need not be discussed here in great detail. As would be appreciated by one skilled in the art, a greater number of pins increases the total contact area between the pins and the foam thus increasing the total conductivity between contact 105 and ESD foam 140. Larger diameter pins increase the displacement pressure and contact area between each pin and the foam thus also increasing the total conductivity between contact 105 and ESD foam 140. Contact 105, when inserted into foam 140, is held in place by friction, from the displacement pressure exerted by foam 140 against the plurality of pins 110. Accordingly, one skilled in the art upon reading this specification could readily determine the thickness and spacing of pins 110 based on the characteristics of the particular ESD foam used including, but not limited to the foam stiffness and thickness. In one embodiment, plurality of pins 110 comprise gold pins, because gold is resistant to oxide buildups which decrease conductivity.

In one embodiment, contact 105 is fabricated from a standard multi-pin (e.g. 16 pin, 24 pin, etc.) dual in-line package (DIP), single in-line package (SIP) or pin grid array (PGA) component header. In one embodiment contact 105 comprises a 16-pin DIP component header with gold plated leads. In one embodiment ground bus 130 comprises the component terminals of a multi-pin component header shorted together with soldered bus wire. In one embodiment, a contact 105, comprising a multi-pin component header having its component terminals shorted together with soldered bus wire is inserted into ESD foam 140 to provide a low-impedance contact to ESD foam 140. Contact 105 is then connected to earth ground 150 through ground connector 135. In one embodiment, a low cost version of contact 105 of the present invention is fabricated by a simple one-piece metal stamping to form a standard dual in-line package pin pattern, or other standard package in pattern.

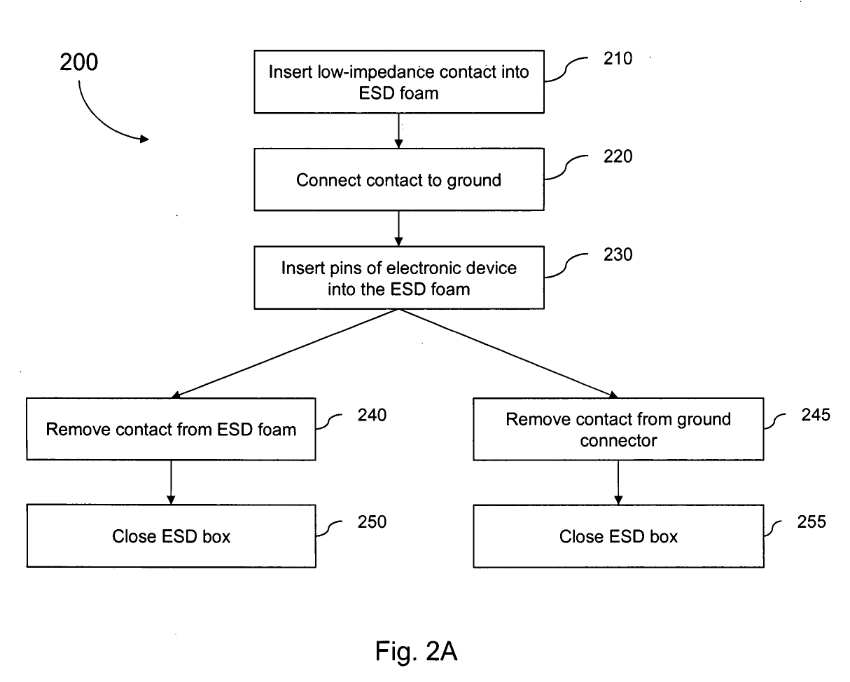

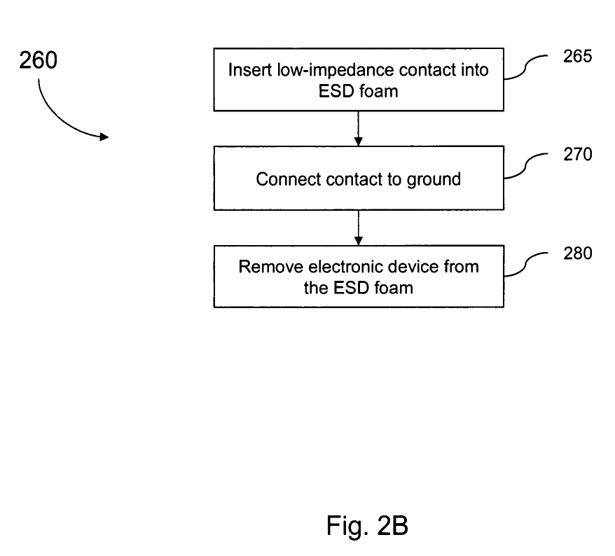

One foreseen use for the present invention is for lab technicians, or similar individuals, who need to handle sensitive electronic devices for transport (e.g. for testing, assembly and transport). Typically, ESD foam is placed within an ESD box which is placed on a grounded ESD mat. Typically, pins of an electronic device are pushed into the ESD foam and then the box is closed and either stored or shipped. FIG. 2A is a flow chart illustrating a method 200 for safely inserting an electronic device into ESD foam of one embodiment of the present invention. In one embodiment, the method comprises inserting a low-impedance contact into the ESD foam (210); connecting the low-impedance contact to ground (220); and inserting the pins of an electronic device into the ESD foam (230). In one embodiment, the operator or mechanism handling the electronic device is continuously connected to the same ground as the ESD foam when inserting the electronic device. Once fully inserted into the ESD foam, all pins of the electronic device are held at the same potential. In one embodiment, the method continues with removing the low impedance contact and ground connector from the ESD foam (240) and closing the ESD box (250). In another embodiment, the low-impedance contact remains with the ESD foam during transport of the electronic device. In that case, the method continues with removing the connection to ground at the low-impedance contact (245) and then closing the ESD box (255). The electronic device can now be safely transported inside the ESD box.

FIG. 2B is a flow chart illustrating a method 260 for safely removing an electronic device from ESD foam of one embodiment of the present invention. In one embodiment, the method comprises inserting a low-impedance contact into the ESD foam (265); connecting the low-impedance contact to ground (270); and removing the electronic device pins from the ESD foam (280). In another embodiment, where the low-impedance contact was previously installed into the ESD foam, the method comprises connecting the low-impedance contact to ground (270); and removing the electronic device pins from the ESD foam (280). In one embodiment, the operator or mechanism handling the electronic device is continuously connected to the same ground as the ESD foam when removing the electronic device.

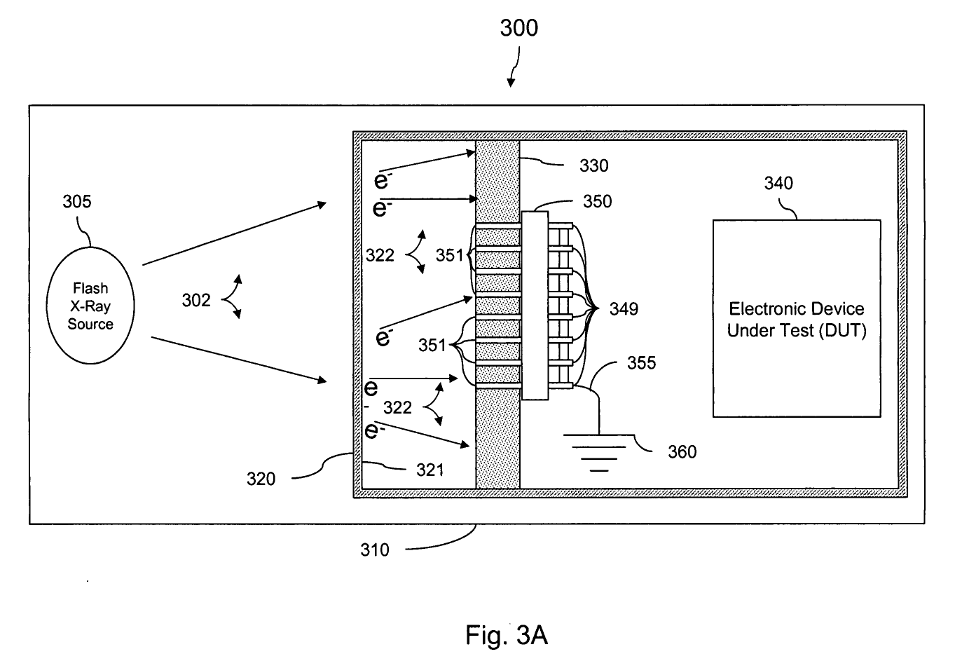

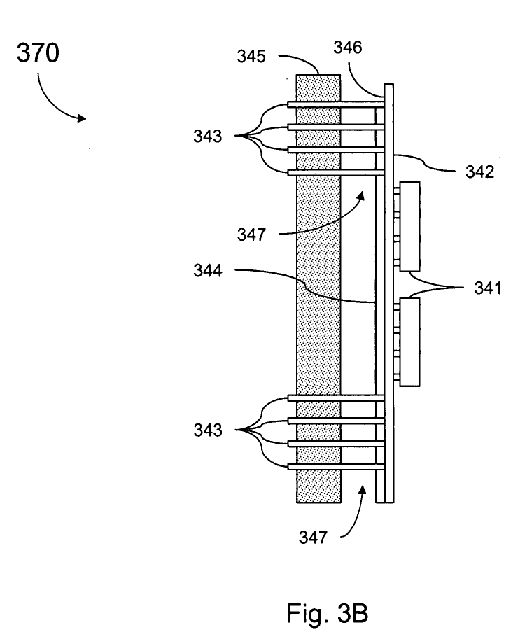

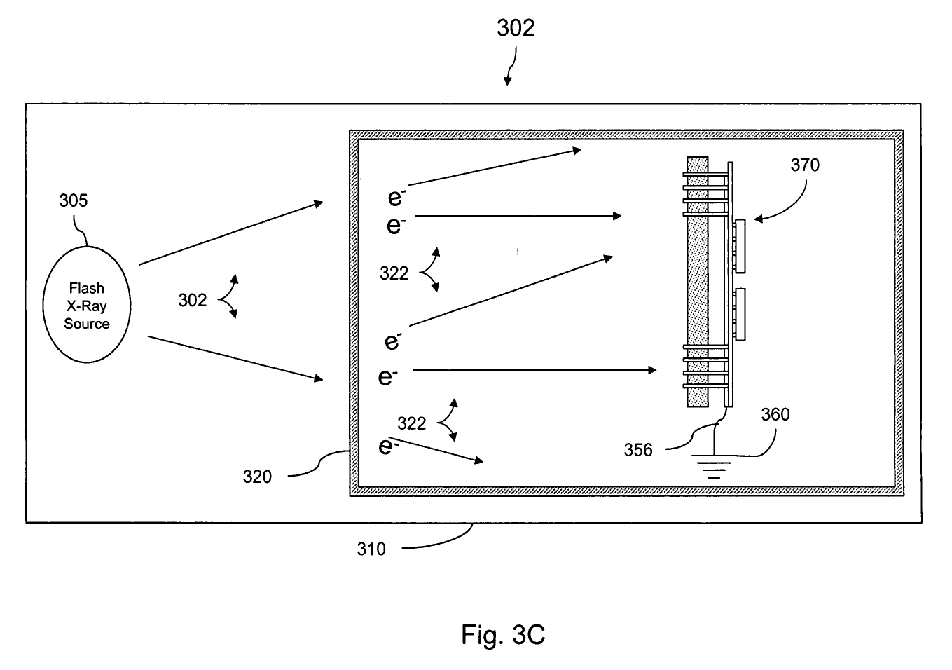

Other embodiments of the present invention 300 provides an electron trap for use with a flash x-ray test system 310 illustrated in FIGS. 3A, 3B and 3C. Referring to FIG. 3A, flash x-rays 302 from source 305 bombard a target electromagnetic interference (EMI) enclosure 320 of flash x-ray test system 310. Secondary emissions 322 in the form of electrons spray from an inside surface 321 of EMI enclosure 320 in response to the flash x-rays 302. Such electron emissions 322 can interfere with the operation of electronic devices. Embodiment 300 comprises a barrier of ESD foam 330 placed between the inside surface 321 of EMI enclosure 320 and electrical device under test (DUT) 340. ESD foam 330 is further adapted with a contact 350 which is electrically coupled to electrical ground 360 through ground connector 355. In one embodiment, contact 350 comprises the elements discussed regarding contact 105 above. In one embodiment, contact 350 comprises a 2×15 pin header with 0.025″×0.025″ gold plated pins on 0.100″ centers. In one embodiment, pins 349 on the printed wiring board (PWB) side of the pin header are shorted together with soldered bus wire while the pins 351 on the connector side of the pin header are inserted into ESD foam 350. The shorted pins 349 are electrically coupled to ground 360 through ground connector 355. In one embodiment, in operation, ESD foam 330 traps secondary electron emissions 322 emanating from the inside surface 321 of EMI enclosure 320 due to flash x-rays 302. As ESD foam 330 traps electrons, the electrons are attracted to the pins of contact 350 which drains the electrons to ground 360 through ground connector 355.

FIG. 3B illustrates another embodiment wherein a printed wiring assembly (PWA) 370 having one or more electronic devices 341 is itself adapted with an electron trap of one embodiment of the present invention. In one embodiment, PWA 370 comprises one or more electronic devices 341 mounted onto a PWB 342. In one embodiment, x-ray facing surface 346 of PWB 342 is adapted with a layer of ESD foam 345 mounted onto one or more low-impedance contacts 347. In one embodiment, contacts 347 each comprise a plurality of pins 343 having elements describe regarding contact 105 above. In one embodiment contacts 347 comprise one or more pin headers mounted to the x-ray facing surface 346 of PWB 342. In one embodiment, pins 343 are electrically connected by a ground bus 344. In one embodiment ground bus 344 comprises one or both of a printed wiring trace or train electrically connected to pins 343. As illustrated in embodiment 302 in FIG. 3C, when PWA 370 is installed into EMI enclosure 320 of flash x-ray test system 310, and ground bus 344 is connected to electrical ground 360 through ground connector 356, PWB 342 and electronic devices 341 are shielded from electron emissions 322. In one embodiment, in operation, ESD foam 345 traps secondary electron emissions 322 emanating from the inside surface 321 of EMI enclosure 320 due to flash x-rays 302. As ESD foam 345 traps electrons, the electrons are attracted to pins 343 of contact 347, which drains the electrons to ground 360 through ground bus 344 and ground connector 356. In one embodiment, ground connector 356 comprises a standard PWB wiring interface connector.

Although examples presented in this specification illustrate embodiments of an electron trap used in combination with a DUT, it would be appreciated by one skilled in the art upon reading this specification that other embodiment of the present invention include electron traps for use in combination with any electronic device where electron emissions can interfere with the operation of electronic device.

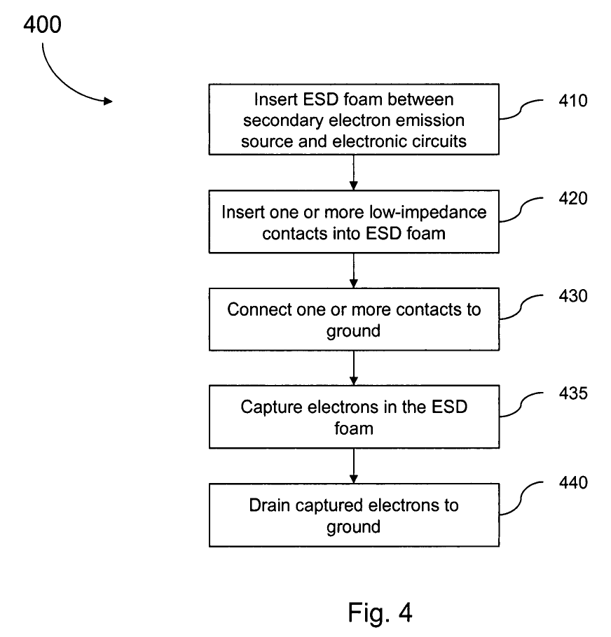

FIG. 4 is a flow chart illustrating a method 400 for shielding electronic circuits from electrons in flash x-tray test systems. In one embodiment, the method comprises inserting a layer of ESD foam between a source of secondary electron emissions and the electronic circuits (410); inserting one or more low-impedance contacts into the ESD foam (420); connecting the one or more low-impedance contacts to ground (430); capturing electrons in the ESD foam (435) and draining captured electrons to ground (440).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An ESD foam ground clip, the clip comprising:
a low-impedance contact; and
a ground connector adapted to electrically connect the low-impedance contact to an electrical ground.

2. The clip of claim 1, the low-impedance contact further comprising:
a holding plate;
a plurality of metal pins, the holding plate adapted to hold the plurality of metal pins approximately parallel to each other; and
a ground bus, the ground bus adapted to electrically couple each of the plurality of metal pins to each other.

3. The clip of claim 2, wherein the low impedance contact further comprises a multi-pin component header.

4. The claim of claim 3, wherein the multi-pin component header is comprised of one of a standard DIP component header, a standard SIP component header, and a standard PGA component header.

5. The claim of claim 3, wherein the ground bus further comprises the plurality of metal pins shorted together with soldered bus wire.

6. The clip of claim 1, wherein the low impedance contact further comprises a metal stamping.

7. The clip of claim 1, wherein the ground connector further comprises a wire lead.

8. The clip of claim 7, wherein the ground connector is adapted to be removabley connected the ground bus of the low impedance contact.

9. The clip of claim 8, wherein the ground connector further comprises one or more of a ball clip terminal, a banana jack, a banana plug, and an alligator clip.

10. The clip of claim 1, wherein the ground connector further comprises one or more of a ball clip terminal, a banana jack, a banana plug, and an alligator clip.

11. The clip of claim 1, wherein the ground connector further comprises a resistor.

12. A method for inserting an electronic device into ESD foam, the method comprising:
inserting a low-impedance contact into the ESD foam;
connecting the low-impedance contact to ground; and
inserting the pins of an electronic device into the ESD foam.

13. The method of claim 12, wherein one or more of a person and a mechanism inserting the pins of the electronic device into the ESD foam are connected to the same ground as the ESD foam.

14. The method of claim 12, further comprising:
removing the low impedance contact from the ESD foam; and
closing an ESD box.

15. The method of claim 12, further comprising:
removing the connection to ground at the low-impedance contact;
closing an ESD box.

16. A method for removing an electronic device from ESD foam, the method comprising:
inserting a low-impedance contact into ESD foam;
connecting the low-impedance contact to ground; and
removing the electronic device pins from the ESD foam.

17. The method of claim 16, wherein one or more of a person and a mechanism removing the electronic device pins from the ESD foam are connected to the same ground as the ESD foam.

18. An ESD foam grounding system, the system comprising:
a low-impedance electrical contact means; and
means for electrically connecting the low-impedance contact means to an electrical ground.

19. The system of claim 18, the low-impedance contact means further comprising:
means for holding a plurality of metal pins approximately parallel to each other; and
means for electrically connecting each of the plurality of metal pins to each other.

20. The system of claim 18, further comprising:
means for increasing a resistance between the low-impedance contact means and the electrical ground.

21. A secondary electron emission shield for a flash x-ray system having electronic devices contained within an EMI enclosure, the shield comprising:
ESD foam adapted with a low-impedance contact, the ESD foam located between a source of secondary electron emissions and the electronic devices; and
a ground connector adapted to electrically connect the low-impedance contact to an electrical ground.

22. The shield of claim 21, the low-impedance contact further comprising:
a holding plate;
a plurality of metal pins, the holding plate adapted to hold the plurality of metal pins approximately parallel to each other; and
a ground bus, the ground bus adapted to electrically couple each of the plurality of metal pins to each other.

23. The shield of claim 22, wherein the low impedance contact further comprises a multi-pin component header.

24. The shield of claim 23, wherein the multi-pin component header is comprised of one of a standard DIP component header, a standard SIP component header, and a standard PGA component header.

25. The shield of claim 22, wherein the ground bus further comprises the plurality of metal pins shorted together with soldered bus wire.

26. The shield of claim 21, wherein the low impedance contact further comprises one-piece metal stamping.

27. The shield of claim 21, wherein the ground connector further comprises a wire lead.

28. The shield of claim 27, wherein the ground connector is adapted to be removabley connected the ground bus of the low impedance contact.

29. The shield of claim 28, wherein the ground connector further comprises one or more of a ball clip terminal, a banana jack, a banana plug, and an alligator clip.

30. The shield of claim 21, wherein the ground connector further comprises one or more of a ball clip terminal, a banana jack, a banana plug, and an alligator clip.

31. The shield of claim 21, wherein the ground connector further comprises a resistor.

32. An apparatus comprising:
a printed wiring board having a first side and a second side, wherein one or more electronic devices are mounted on one or more of the first side and the second side;
one or more low-impedance contacts mounted on one or more of the first side and the second side;
a ground bus adapted to electrically couple the one or more low-impedance contacts together; and
ESD foam mounted onto the one or more low-impedance contacts between a source of secondary electron emissions and the one or more electronic devices.

33. The apparatus of claim 32, further comprising:
a ground connector adapted to electrically connect the ground bus to an electrical ground.

34. A method for shielding electronic devices from secondary electron emissions in a flash x-tray test system, the method comprising:
inserting a layer of ESD foam between a source of secondary electron emissions and the electronic devices;
inserting one or more low-impedance contacts into the ESD foam;
connecting the one or more low-impedance contacts to ground;
capturing electrons in the ESD foam; and
draining electrons captured by the ESD foam to ground.

35. A secondary electron emission shield for a flash x-ray system having electronic devices contained within an EMI enclosure, the shield comprising:
means for adapting ESD foam with a low-impedance electrical contact; and
means for electrically connecting the low-impedance electrical contact to an electrical ground.

36. The system of claim 35, the low-impedance contact further comprising:
means for conducting electrical charges;
means for holding a plurality of metal pins approximately parallel to each other; and
means for electrically connecting each of the plurality of metal pins to each other.

37. The system of claim 35, further comprising:
means for increasing a resistance between the low-impedance electrical contact and the electrical ground.

38. A low impedance contact, the contact comprising:
a plurality of metal pins;
a holding plate adapted to hold the plurality of metal pins approximately parallel to each other; and
a ground bus, the ground bus adapted to electrically couple each of the plurality of metal pins to each other.

39. The contact of claim 38, wherein the ground bus further comprises the plurality of metal pins shorted together with soldered bus wire.

40. The contact of claim 38, further comprising
a ground connector adapted to electrically connect the ground bus to an electrical ground.

41. The contact of claim 40, wherein the ground connector further comprises a wire lead.

42. The contact of claim 41, wherein the ground connector is adapted to be removabley connected the ground bus of the low impedance contact.

43. The contact of claim 41, wherein the ground connector further comprises one or more of a ball clip terminal, a banana jack, a banana plug, and an alligator clip.

44. The contact of claim 41, wherein the ground connector further comprises a resistor.
